(19) United States
(12) Patent Application Publication
(10) Pub. No.: US 2017/0011471 A1
(43) Pub. Date: Jan. 12, 2017

(54) METHODS AND SYSTEMS OF A COMMISSION-PLAN DOCUMENT DESIGN APPLICATION

(71) Applicant: gopi MATTEL, half moon bay, CA (US)

(72) Inventor: gopi MATTEL, half moon bay, CA (US)

(21) Appl. No.: 15/197,742

(22) Filed: Jun. 29, 2016

Related U.S. Application Data
(60) Provisional application No. 62/185,723, filed on Jun. 29, 2015.

(51) Int. Cl. G06Q 40/00

(52) U.S. Cl. CPC G06Q 40/125; G06Q 50/188

(57) ABSTRACT

In one aspect, a method implementing a commission-plan document designer application includes the step of providing a sales-commission plan document. The sales-commission plan document comprises a digital document. The method includes the step of providing a set of rules that govern a sales-commission calculation for when a sales representative receives credit for a sale. The method includes the step of generating a set of sales-commission computer-executable algorithms for calculating the sales commission based on the set of rules. The method includes the step of embedding the set of rules that govern a sales-commission calculation and the set of sales-commission computer-executable algorithms into the sales-commission plan document to generate an executable sales-commission plan document. The method includes the step of storing the executable sales-commission plan document in the computer memory. Optionally, upon completion of a sale, the method can include the step of providing a sale data to a calculation engine of the en mission-plan document designer application. The calculation engine based on the set of sales-commission computer-executable algorithms from the executable sales-commission plan document and automatically calculates a pay-out amount to the sales representative.

### CROSS-REFERENCE TO RELATED APPLICATIONS

This application is a claims priority to U.S. provisional patent application no. 62/185,723, filed on Jun. 29, 2015. This provisional application is hereby incorporated by reference in its entirety.

### BACKGROUND

An enterprise may use a commission-based form of remuneration for sales agents. The payment of commission as remuneration for services rendered or products sold is a common way to reward sales agents. For example, payments often are calculated on the basis of a percentage of the goods sold. The enterprise and a sales agent can agree to a commission plan document. The commission plan document can provide the rules that govern how the commission remuneration is to be calculated. However, current forms of commission plan documents can be static and negotiated on a one-on-one basis. For example, various factors can trigger the drafting of the new commission plan document. This can include hiring a new sales agent, or changing a current sales agent's status (e.g. new region, new customers, new products, new product pricing, etc.). Additionally, current methods may require an account or other payroll entity to review the commission plan document and then calculate the amount of compensation. The payroll entity can make mistakes during this manual process. Accordingly, improvements to applications used to generate and use commission plan documents are desired.

### BRIEF SUMMARY OF THE INVENTION

In one aspect, a method implementing a commission-plan document designer application includes the step of providing a sales-commission plan document. The sales-commission plan document comprises a digital document. The method includes the step of providing a set of rules that govern a sales-commission calculation for when a sales representative receives credit for a sale. The method includes the step of generating a set of sales-commission computer-executable algorithms for calculating the sales commission based on the set of rules. The method includes the step of embedding the set of rules that govern a sales-commission calculation and the set of sales-commission computer-executable algorithms into the sales-commission plan document to generate an executable sales-commission plan document. The method includes the step of storing the executable sales-commission plan document in the computer memory.

Optionally, upon completion of a sale, the method can include the step of providing a sale data to a calculation engine of the commission-plan document designer application. The calculation engine can be based on the set of sales-commission computer-executable algorithms from the executable sales-commission plan document and can automatically calculate a pay-out amount to the sales representative.

### BRIEF DESCRIPTION OF THE DRAWINGS

FIG. 1 illustrates a table that includes information used to store plan-related information, according to some embodiments.

FIG. 2 illustrates a table that includes information used to store plan related information, according to some embodiments.

FIG. 3 illustrates a table that includes information used to store plan related information, according to some embodiments.

FIG. 4 illustrates an example header section of a commission-plan design document, according to some embodiments.

FIG. 5 illustrates an example description section of the plan document, according to some embodiments.

FIG. 6 illustrates an example duration section of the plan document, according to some embodiments.

FIG. 7 illustrates an example draw section of the plan document, according to some embodiments.

FIG. 8 illustrates an example cap section of the plan document, according to some embodiments.

FIG. 9 illustrates an example summary payout section of the plan document, according to some embodiments.

FIG. 10 illustrates an example plan approval section of the plan document, according to some embodiments.

FIG. 11 illustrates an example element of a runtime section of the plan document, according to some embodiments.

FIG. 12 illustrates an example table with a data model of the incentives and rules information, according to some embodiments.

FIG. 13 illustrates an example incentive section that can be controlled by the data model of table 1202, according to some embodiments.

FIG. 14 illustrates example elements of a goals section of the plan document, according to some embodiments.

An example credit section is provided in FIG. 15, according to some embodiments.

FIG. 16 illustrates an example table that describes a data plan for determining incentive credits, according to some embodiments.

FIG. 17 illustrates an example table that describes a data plan for determining incentive credit details, according to some embodiments.

FIG. 18 illustrates example elements of a commission-rate section of the plan document, according to some embodiments.

FIG. 19 illustrates example tables that describe data plans for determining commission rates, according to some embodiments.

FIG. 20 illustrate example tables that describe data plans for determining commission rates, according to some embodiments.

FIG. 21 illustrate example tables that describe data plans for determining commission rates, according to some embodiments.

FIG. 22 illustrates example elements of a calculate-payout section of the plan document, according to some embodiments.

FIG. 23 illustrates example tables that describe data plans for calculating payout rates, according to some embodiments.

FIG. 24 illustrates an example of an add-new rules section of a plan document, according to some embodiments.

FIG. 25 illustrates a set of entities and each entity's particular permissions with respect to various commission-plan document modes, according to some embodiments.

FIG. 26 illustrates an example system used to logically store commission-plan document data in the system.

FIG. 27 illustrates an example system used to logically store commission-plan document data in the system.

FIG. 28 depicts an exemplary computing system that can be configured to perform any one of the processes provided herein.

FIG. 29 is a block diagram of a sample-computing environment that can be utilized to implement various embodiments.

FIG. 30 illustrates an example screenshot implementing a multi-dimensional rate lookup, according to some embodiments.

FIG. 31 illustrates an example screenshot implementing sales commission modeling, according to some embodiments.

The Figures described above are a representative set and are not exhaustive with respect to embodying the invention.

### DESCRIPTION

Disclosed are a system, method, and article of manufacture for methods and systems of a commission plan document design application. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application programming interface (API) can specify how software components of various systems interact with each other.

Cloud computing can involve deploying groups of remote servers and/or software networks that allow centralized data storage and online access to computer services or resources. These groups of remote servers and/or software networks can be a collection of remote computing services.

Commission can be a form of remuneration. More specifically, a form of payment to an agent for services rendered (e.g. sales services, etc).

Portable Document Format (PDF) can be a file format used to present documents in a manner independent of application software, hardware, and operating systems.

Rich text can include styling information beyond the minimum of semantic elements, such as, inter alia: colors, styles (e.g. boldface, italic), sizes, and special features (e.g. hyperlinks).

Web-based application refers to any program that is accessed over a network connection using Hypertext Transfer Protocol (HTTP), rather than existing within a device's memory. Web-based applications often run inside a Web browser. However, Web-based applications also may be client-based, where a small part of the program is downloaded to a user's desktop, but processing is done over the Internet on an external server.

Word processor computer-software application can be the composition, editing, formatting, and sometimes printing of any sort of digitally written material.

### Exemplary Methods

The commission-plan designer application can be a web-based application. The commission-plan designer application can be a user interface type that presents a user (e.g. an administrator of commission plans for an enterprise) with a. sequence of dialog boxes and other user-input, elements that lead the user through a series of well-defined steps. The commission-plan designer application can include three attributes, inter alia: a document, a document and roles, rules. A document can provide. a complete picture of a commission plan and its attributes in a non-editable format. The document can support features such as, print, export as PDF and for a word processor computer-software application document (e.g. Microsoft Word® document). The document can be embedded with computer-executable rules to then have both document and rule attributes. In a document and rule attribute mode, a commission-plan document can be created/modified/deleted. Rules can be provided/defined.

In some examples, the commission-plan designer application can embed the rules that govern commission calculation into the commission-plan document. Rules can be provided that govern when the sales representative can receive credit for sales. Example rules can include, inter alia: limits to geography, customer identifiers, product lines, etc. For example, sales representatives may only receive commissions in a specified territory for a specified product line sold to specific customers. Rules can also govern other attributes of the commission calculation process, such as: percentage of sales profits used for commission, setting of quotas, duration of agreement, etc. For example, flat rate can have more complex rules up to eighty-percent (80%) of quota then rate is ‘x’, from 80% to 90% then it is ‘y’, above that it is ‘z’, etc. The text can be in rich text format or other document file format. The rules can be stored as Extensible Markup Language (XML). In other examples, the rules can be stored in other formats such as JavaScript Object Notation (ISDN), PSI) (Photoshop document), other markup languages, etc.

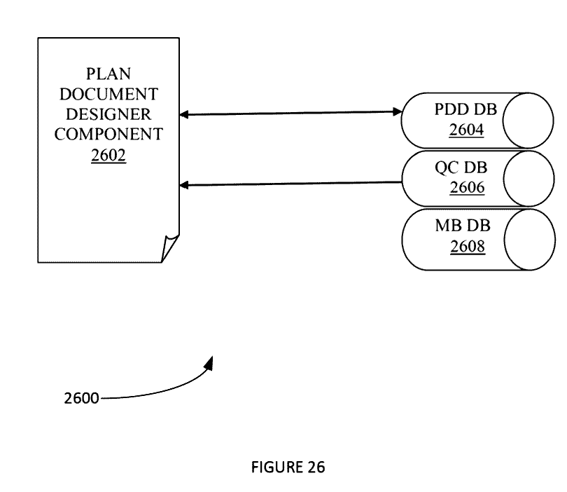

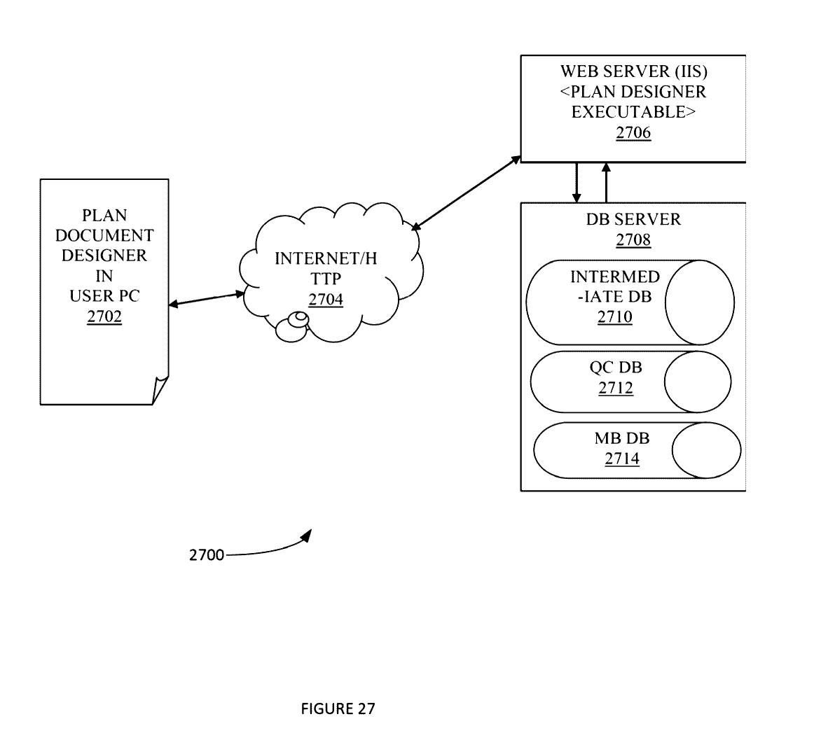

it is noted that the commission-plan document can include computer-executable algorithms for calculating commissions based on selected rules. The commission-plan document can include buttons and other graphical-control elements (e.g. text boxes, check boxes, radio buttons, etc.) used to input rules and to generate the results of the calculation. Commission plans and associated rules can be stored in databases (e.g. see databases of FIGS. 26 and 27 provided infra). A graphical-control element can be an element of interaction in a graphical user interface (GUI), such as a button or a scroll bar. A text box can be a graphical control element intended to enable the user to input text information to be used by an executable format of commission-plan document. A check box can be a graphical user interface (GUI) widget that permits the user to make a binary choice. A radio button can be a GUI widget that permits the user to choose one of a predefined set of options.

The selected/input rules of a commission-plan document can be provided to a calculation engine. A calculation-engine can receive the rules and text information and calculates commission parameters. Upon receiving final sales data for a period of time set for commission payments (e.g. weekly, quarterly, etc.), the calculation engine can use the commission parameters to calculate a sales representative's commission payments.

The commission-plan document can be an executable document that has the look of a plan document to a sale representative. Accordingly, the commission-plan document can be a legally binding document that can be signed by all relevant parties. In one example, the commission-plan document can determine a history of parties that viewed it. For example, it can include computer logic that causes a record of viewing parties to be stored in a computer database for later retrieval. A commission-plan document can provide evidence that all signatories that viewed the document in a digital format,

Document pages can support various document design Options, such as, pagination options (e.g. previous, next, first, last, etc.). These pagination options can assist user in navigating to different plans. In rule attribute mode, only rules are available and do the same as with document and rule attribute mode.

### Example Document and Rule Attributes

The following section provides additional information for the document and rule attributes. The plan elements can be defined in a structure called ‘sections’. The sections define the plan with a meaningful name and a description. The section's function can provide an option in the top to ‘Add content section’ for more than one section. The section's function can also specify the order of the storage of the element. This can include two types of elements: pre-defined elements and elements at run-time. A pre-defined element can illustrate the functional behavior of the plan. A pre-defined element can be static. Example pre-defined elements can include description, duration, incentive, draw, cap, summary payout, and/or approval. An example description can include text describing a part of the plan. An example of duration can include a duration of the plan or elements thereof. An example incentive can include a set of calculations to provide a payout. A draw can be an advance against future earnings. A cap can be a limit against payouts. A summary of payouts can include the total payouts for a plan and a period. An approval can include an approval of plan for execution.

The elements at run-time can be defined based on the end user's plan requirement. Elements at run-time can be dynamic. In one example, elements at run-time can include: agreement, extra information, incentive etc. An agreement can include additional terms and conditions. Extra information can include additional information related to the plans. An incentive can include a set of calculations to provide a payout.

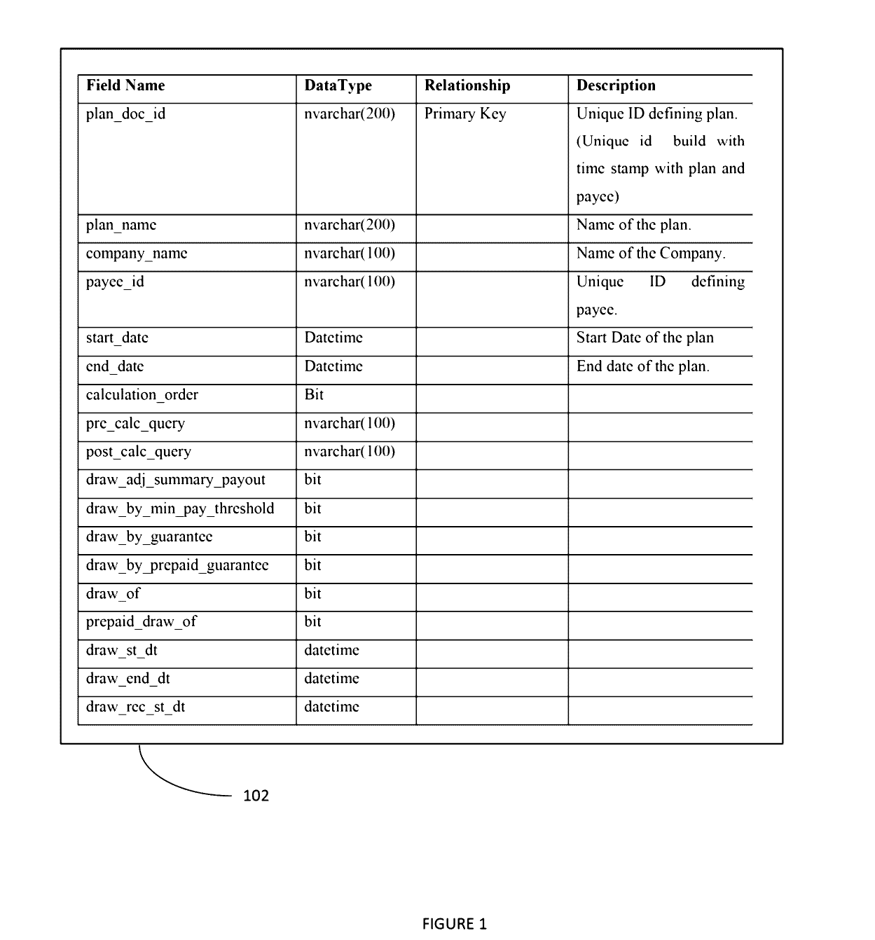

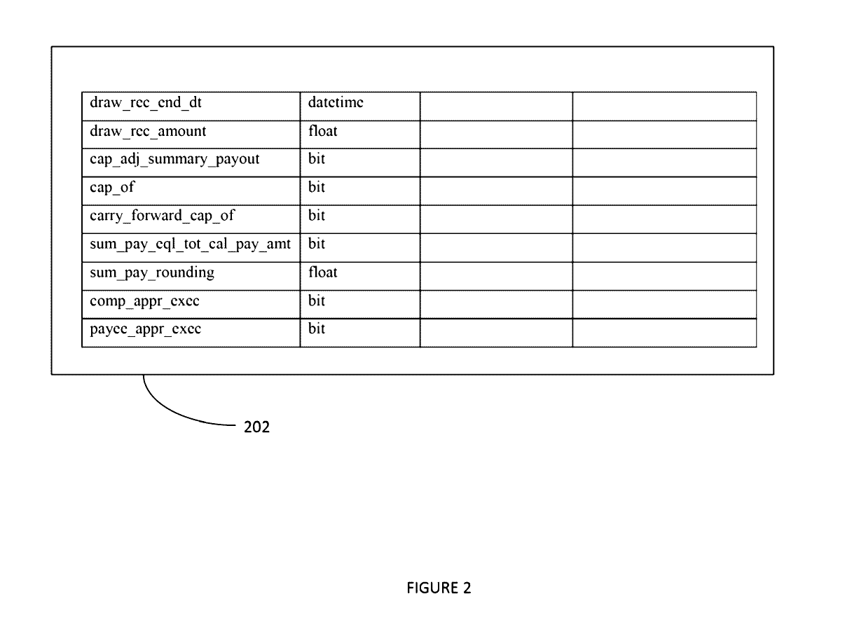

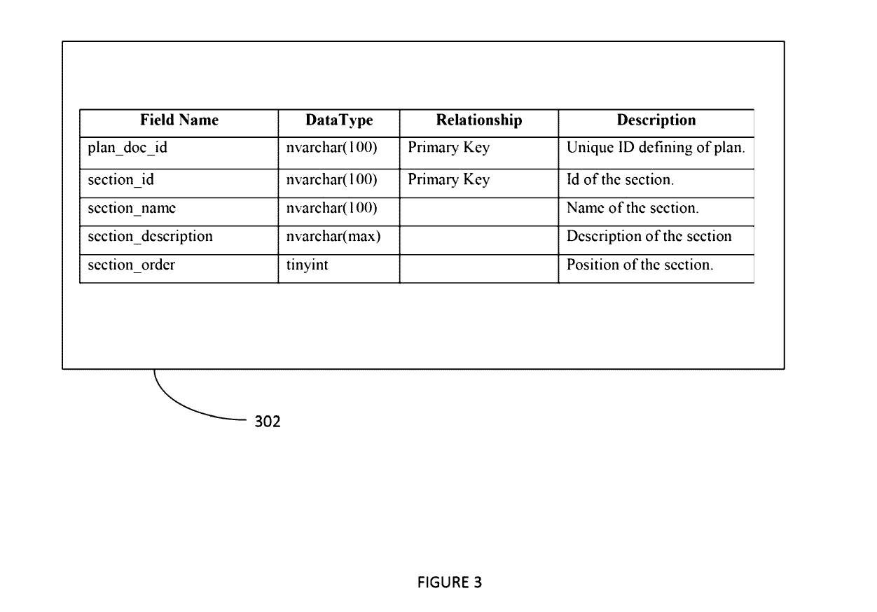

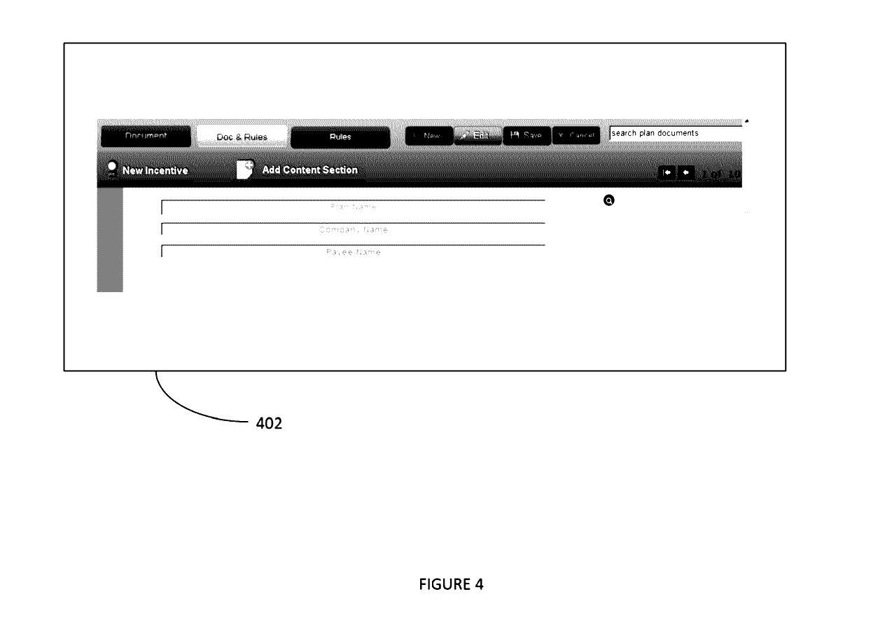

The following FIGS. 1-13 illustrate a detailed picture of the elements at run-time and its data model in a table format. More specifically, FIGS. 1, 2 and 3 illustrate tables 102, 202 and 302 that include information used to store plan-related information, according to some embodiments. More specifically, the tables include element field names, data-types, relationships and descriptions. The information of tables 102, 202 and 302 can be utilized to generate and manage the functionality of the document portions in FIGS. 4-11 and 13.

FIG. 4 illustrates an example header section 402 of a commission-plan design document, according to some embodiments. Header section 402 can receive such plan information, inter alia: plan name, company name and payee. The company name will be fetched from the table of company attributes. The payee name can be listed in the control based on the company being selected. Based on the company name, the corresponding logo can be displayed in the logo section.

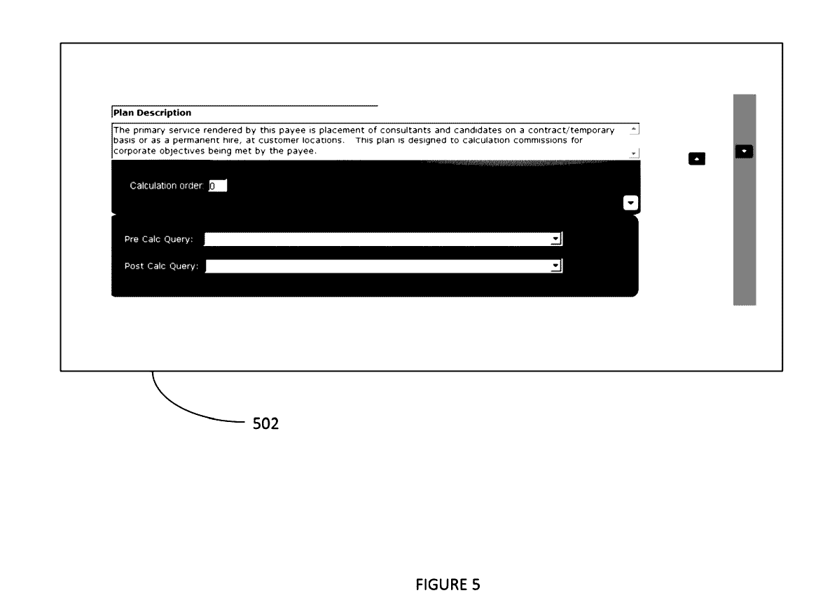

FIG. 5 illustrates an example description section 502 of the plan document (e.g. a sales-commission plan, etc.), according to some embodiments. The description gives the detailed information of the plan. The other options can include, inter alia: calculation order, pre-calculation query and/or post-calculation query. Pre-calculation query and post-calculation query can be used to lookup values that are fetched from the QC tables (see infra).

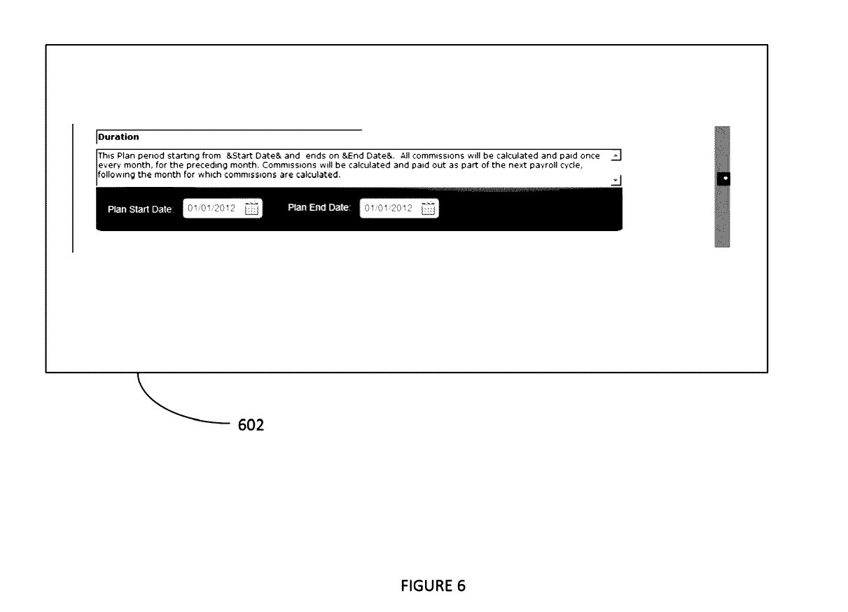

FIG. 6 illustrates an example duration section 602 of the plan document, according to some embodiments. The start and the end date can be entered in the duration element by expanding the button on the right hand side of the element.

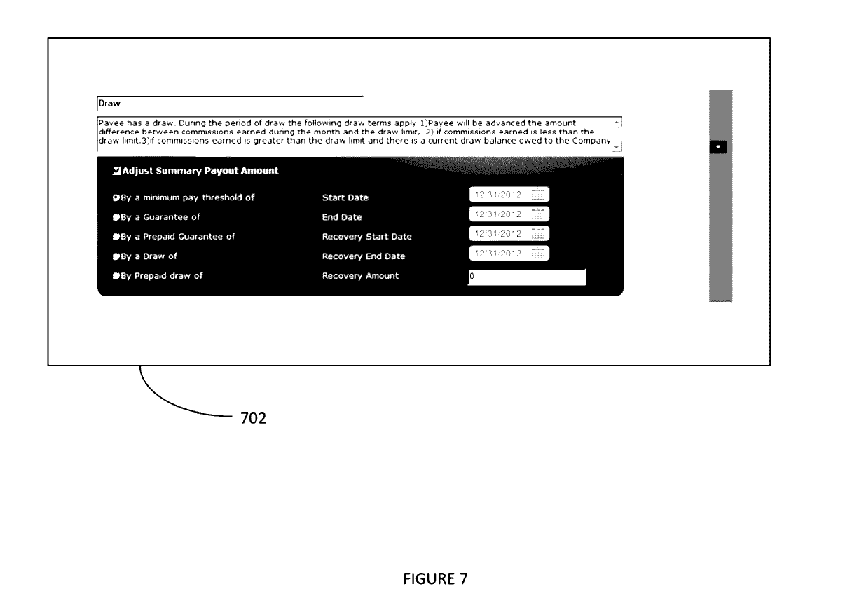

FIG. 7 illustrates an example draw section 702 of the plan document, according to some embodiments. The draw section description can provide the detailed information of the plan draw. Draw is an advance against future earnings. The draw section can include various advanced options. In one example, the advanced options can include various features like, inter alia, pay threshold, guarantee, prepaid guarantee, etc.

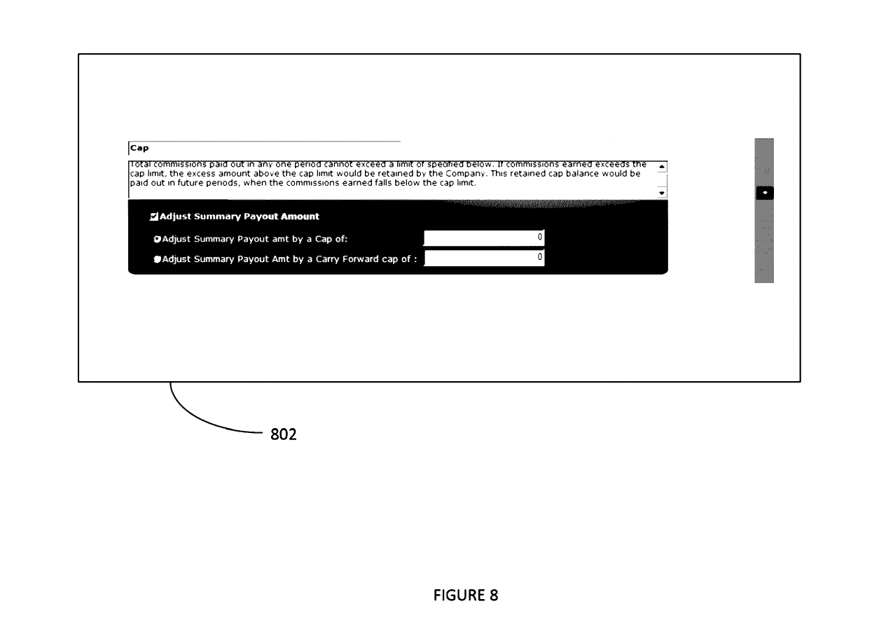

FIG. 8 illustrates an example cap section 802 of the plan document, according to some embodiments. The cap description can provide various detailed information of the plan cap. Cap is a limitation on payouts. The advanced options can include various features like, inter alia: adjust summary payout by cap, carry forward of, etc.

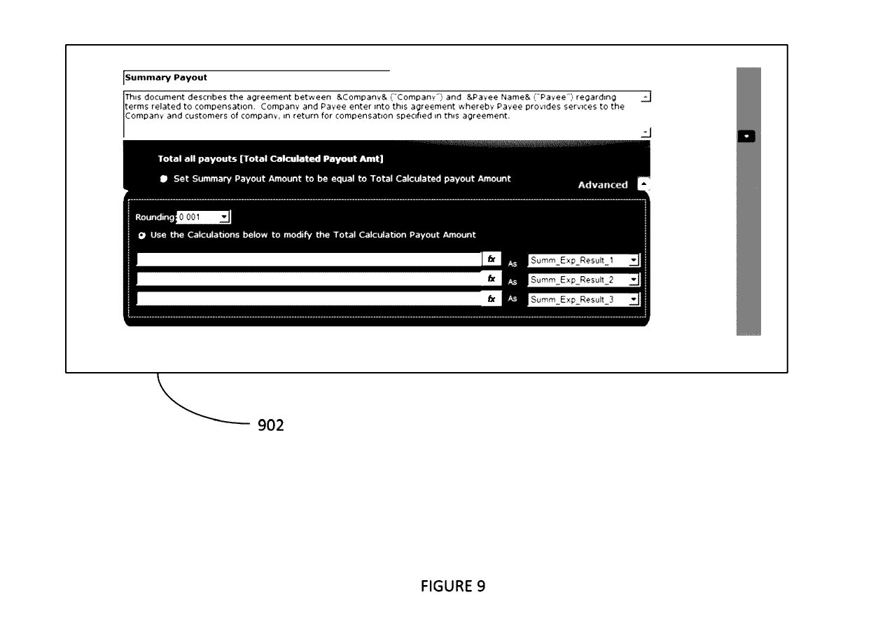

FIG. 9 illustrates an example summary payout section 902 of the plan document, according to some embodiments. The description can provide the detailed information of the summary payout. The advanced options can include includes various features, such as, setting the summary payout to the calculated payout, rounding options, calculations to modify the total calculation payout amount, etc.

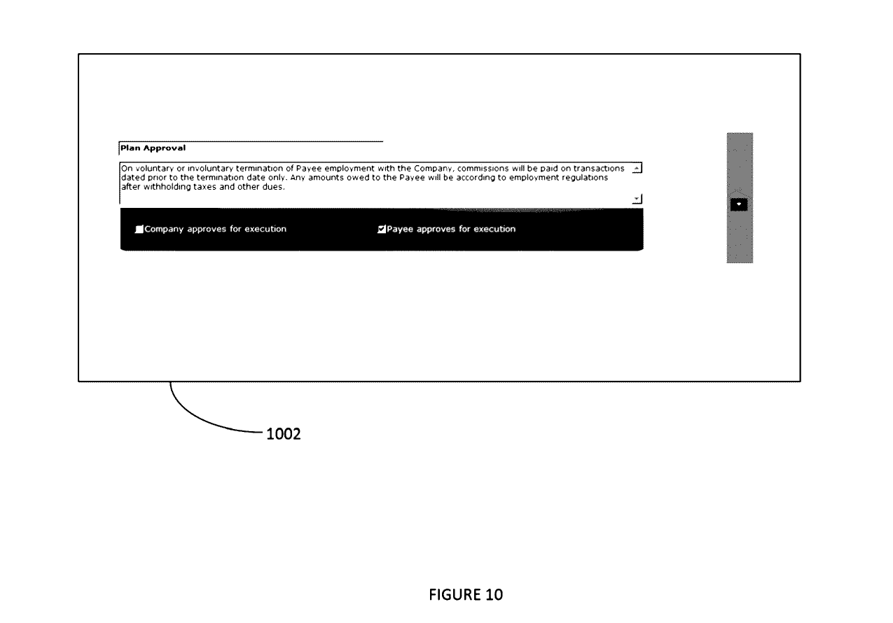

FIG. 10 illustrates an example plan approval section 1002 of the plan document, according to some embodiments. The approval section can conclude the plan for execution. The approval section can include both company and/or payee approvals.

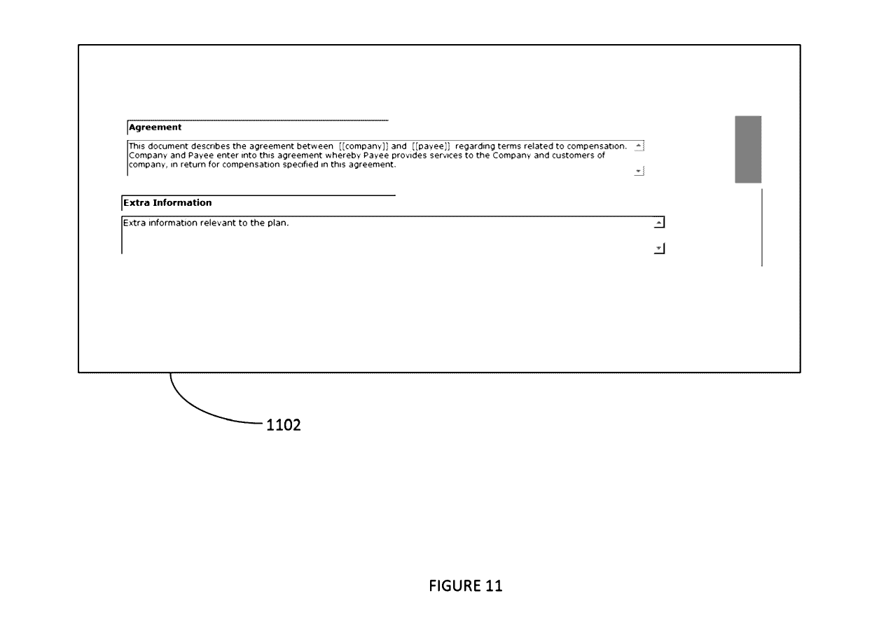

FIG. 11 illustrates an example element of a runtime section 1102 of the plan document, according to some embodiments. It is noted that few elements can have usage that is determined at run time based on the plan requirement. These can include: Agreement1, Agreement2, extra information, etc.

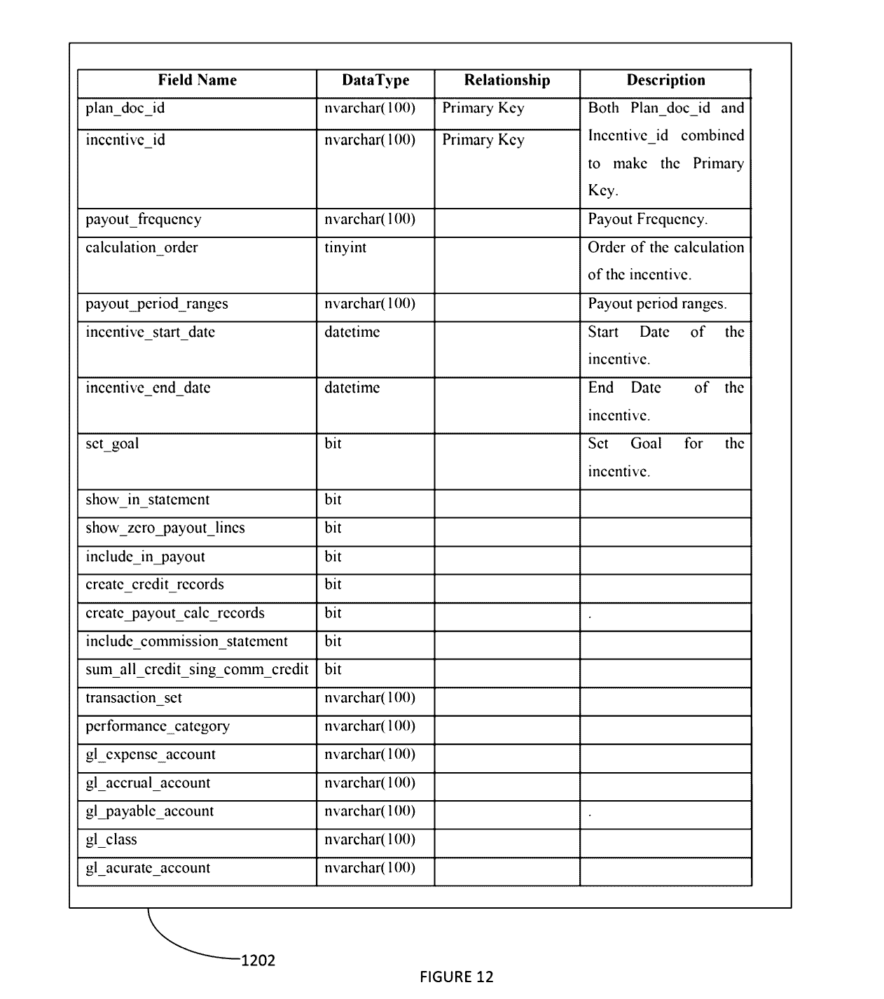

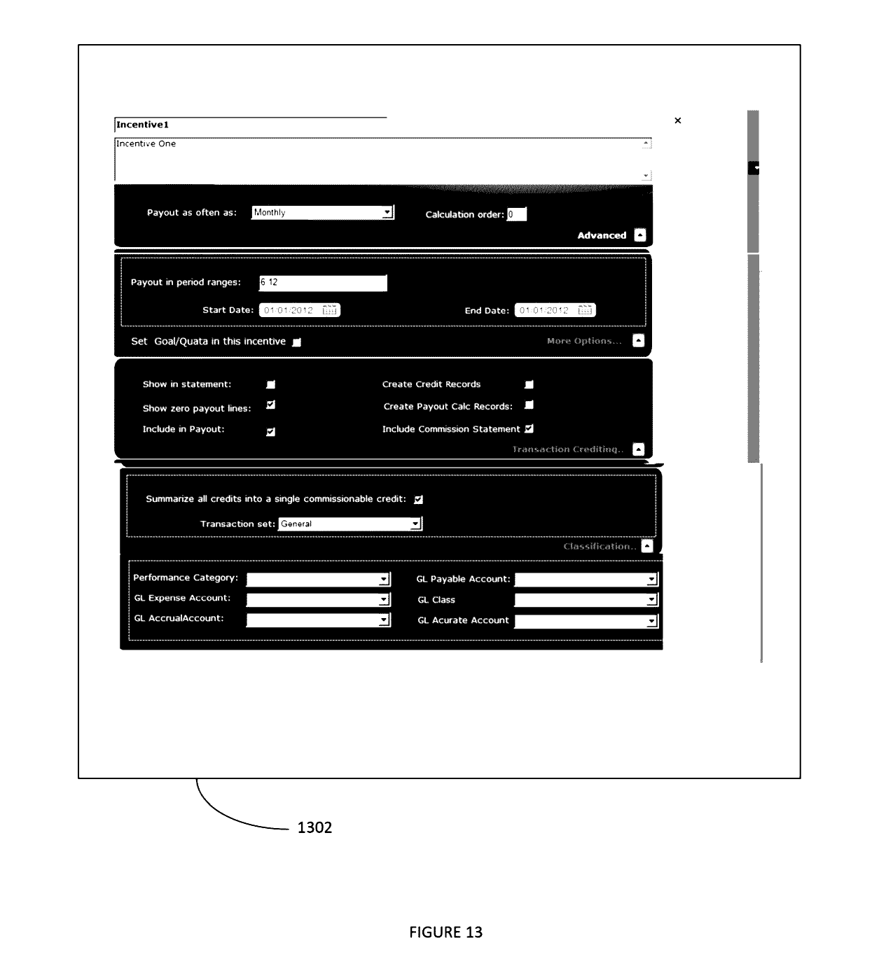

FIG. 12 illustrates an example table 1202 with a data model of the incentives and rules information, according to some embodiments. The incentive can define the functional behavior of the plan. It is noted that there can be one or more incentives in a plan. The calculation order can define the order of execution. The calculation order can have an option ‘add incentive’ at the top to add more incentives input. The various rules involved can include, inter alia: goal, credit, commission rate and/or calculate payout. Accordingly, FIG. 13 illustrates an example incentive section 1302 that can be controlled by the data model of table 1202, according to some embodiments.

### Exemplary Rules Input

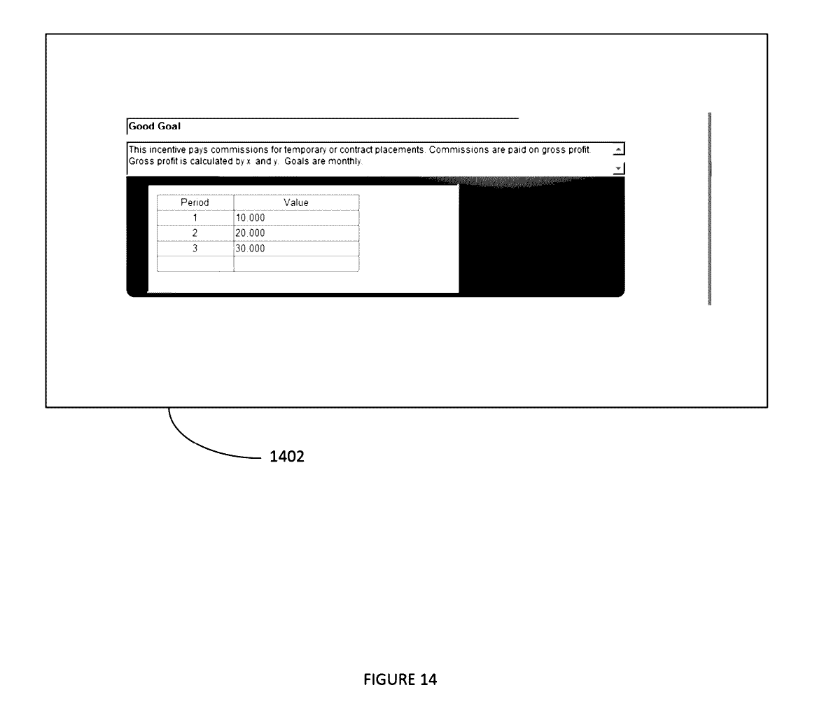

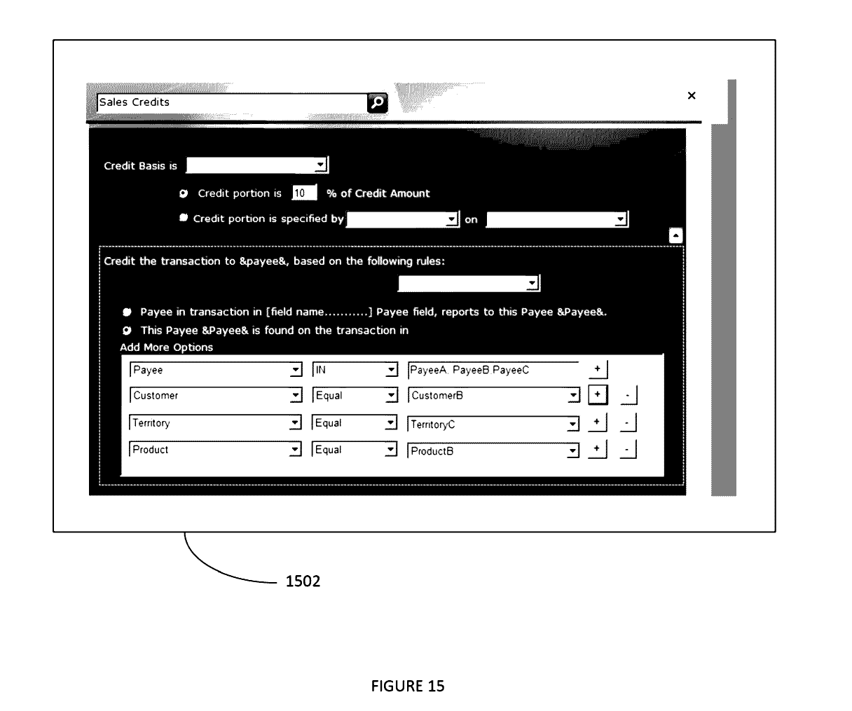

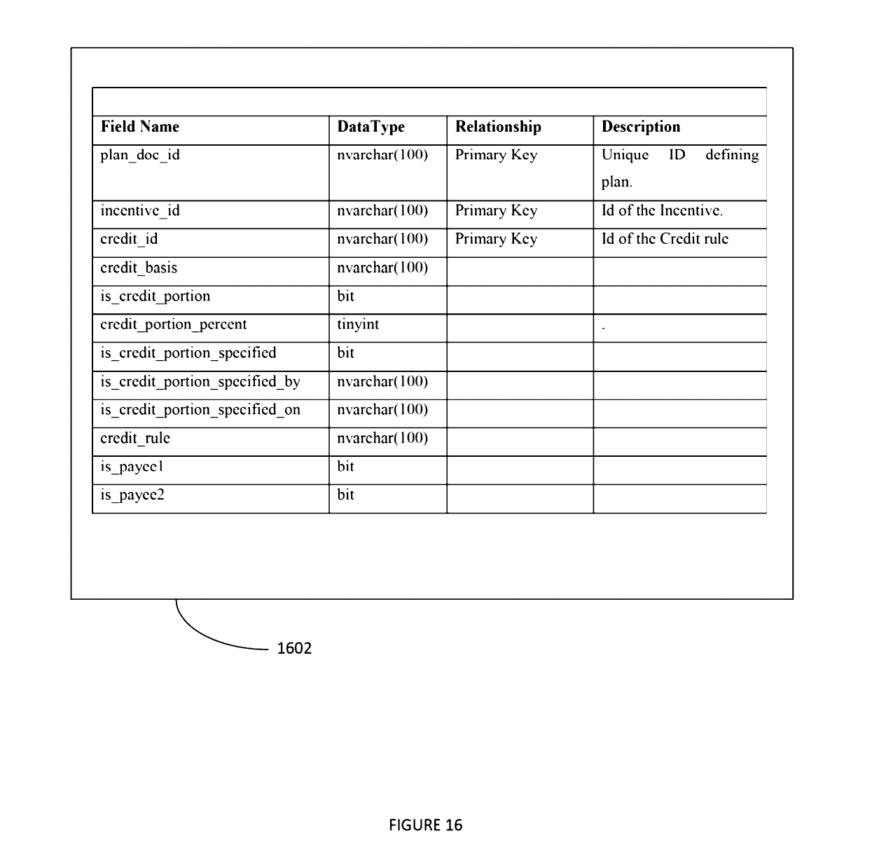

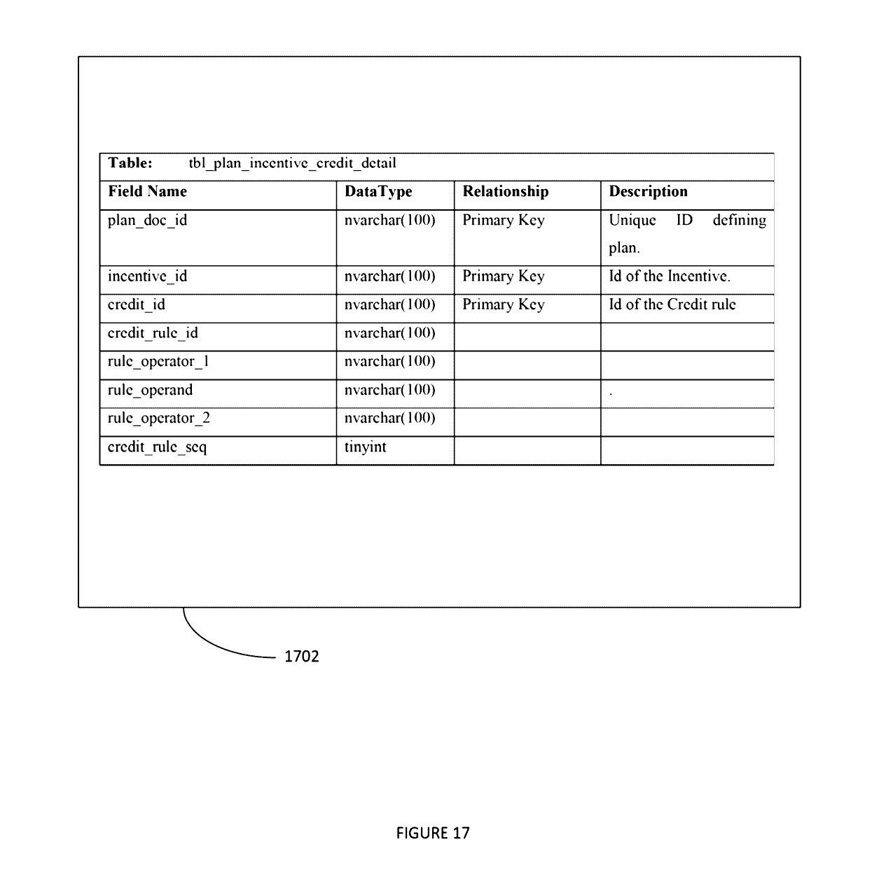

FIG. 14 illustrates example element of a goals section 1402 of the plan document, according to some embodiments. The goal, credit, commission rate and calculate payout can be defined as various rules in an incentive (e.g. see FIG. 13 supra). Goals section 1402 has the options to list and/or add new rules. In some examples, goals section 1402 can have one goal, commission rate and calculate payout. In contrast, goals section 1402 can have one or more credits. An example credit section 1502 is provided in FIG. 15, according to some embodiments. FIG. 16 illustrates an example table 1602 that describes a data plan for determining incentive credits, according to some embodiments. FIG. 17 illustrates an example table 1702 that describes a data plan for determining incentive credit details, according to some embodiments.

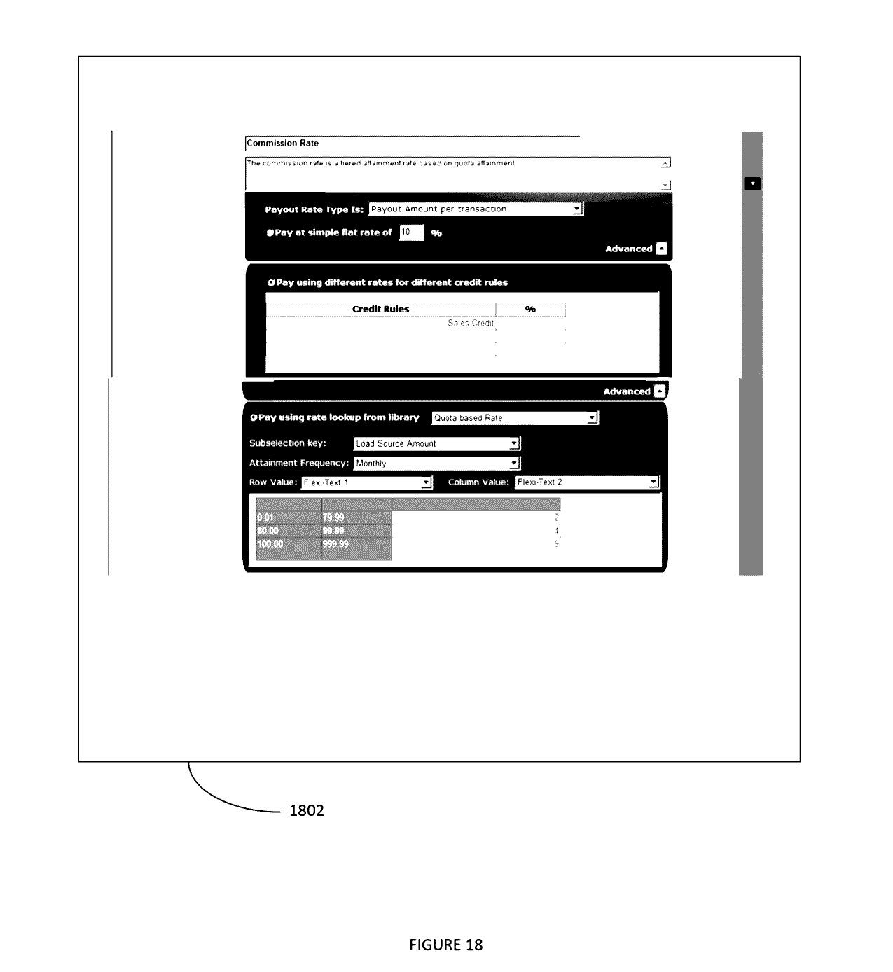

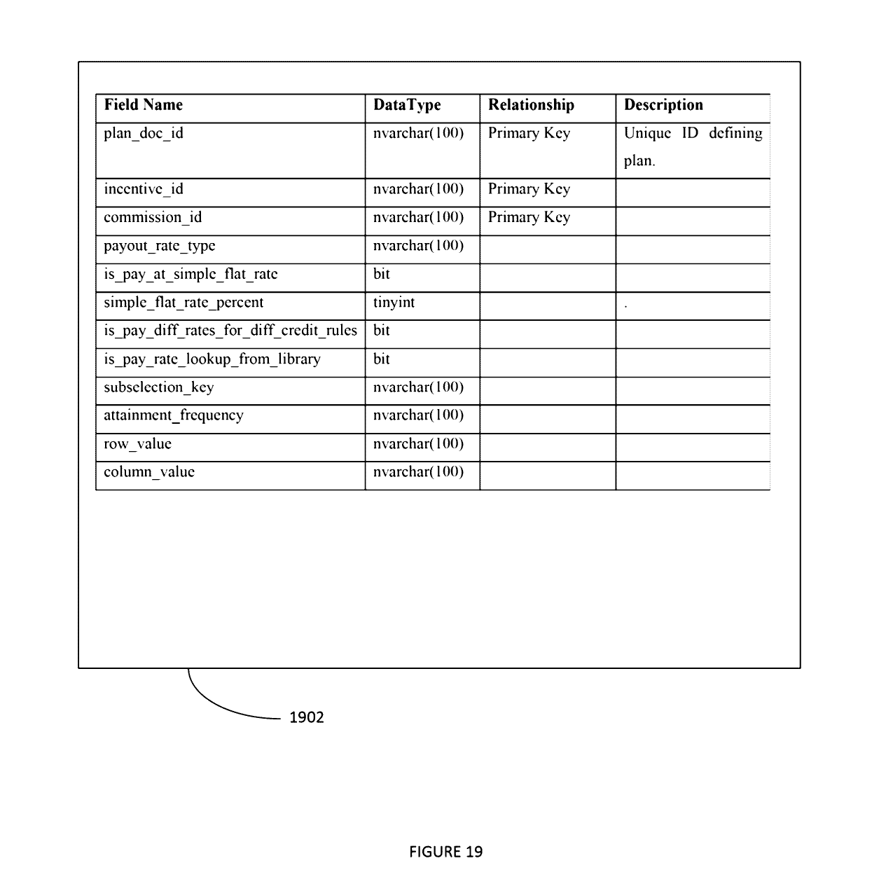

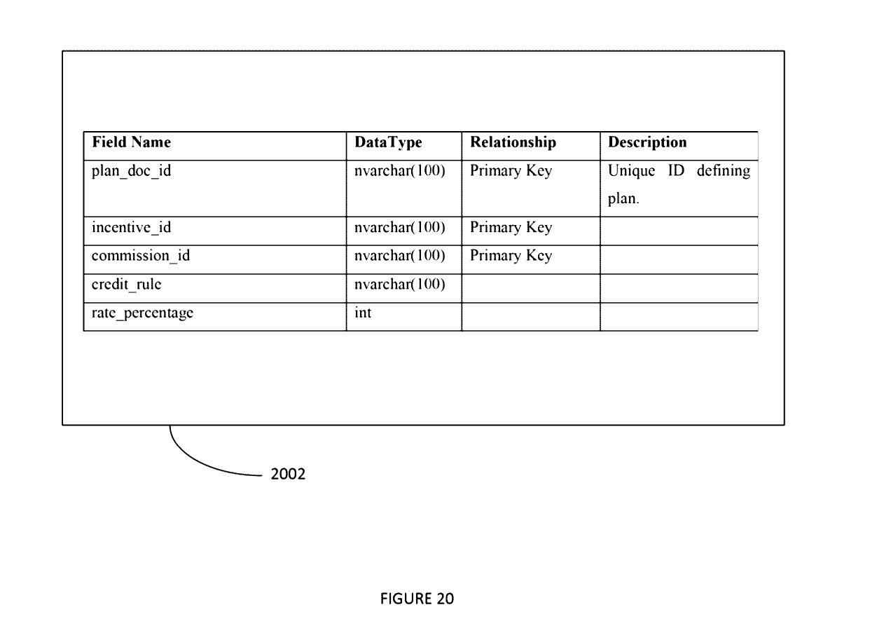

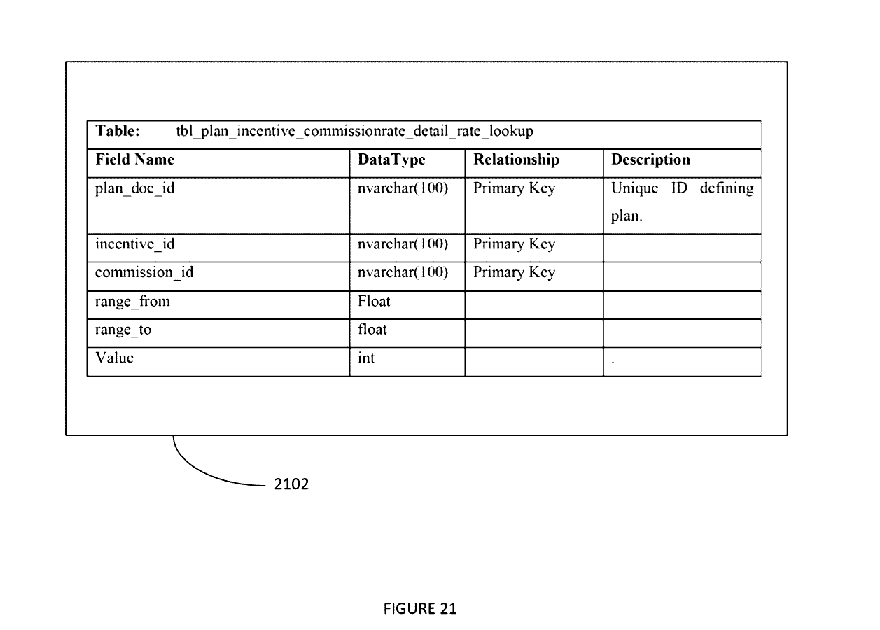

FIG. 18 illustrates an example element of a commission-rate section 1802 of the plan document, according to some embodiments. FIGS. 19-21 illustrates example tables 1902-2102 that describe data plans for determining commission rates, according to some embodiments.

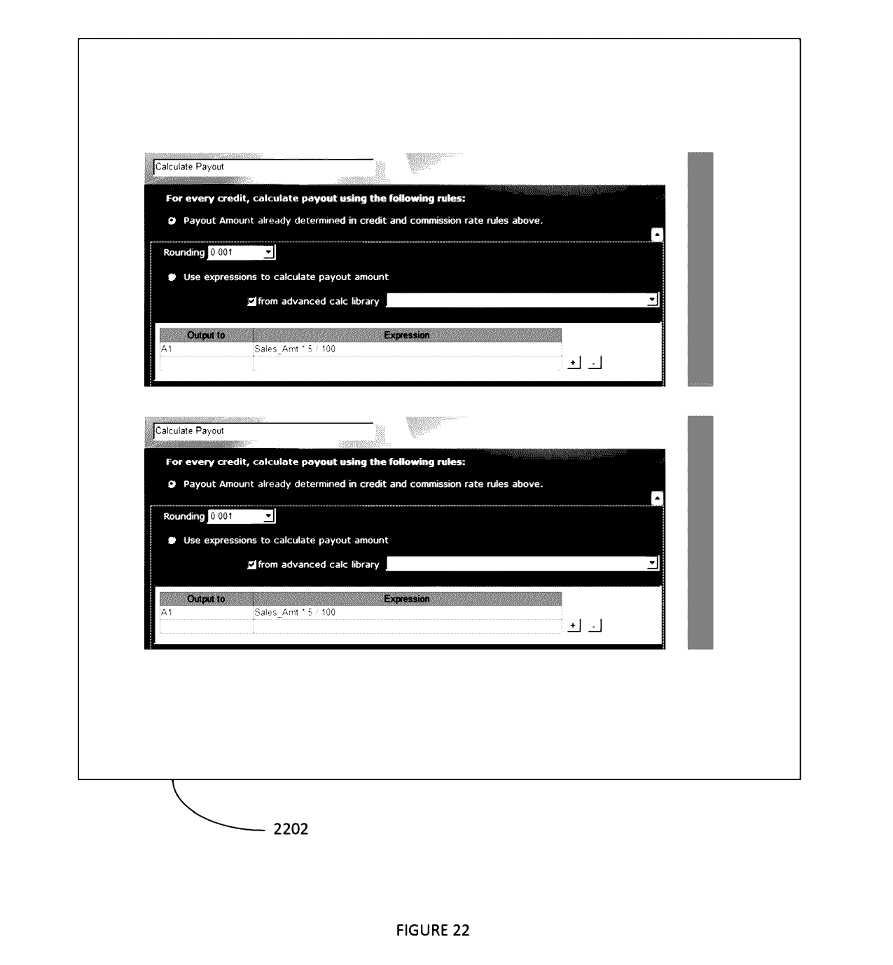

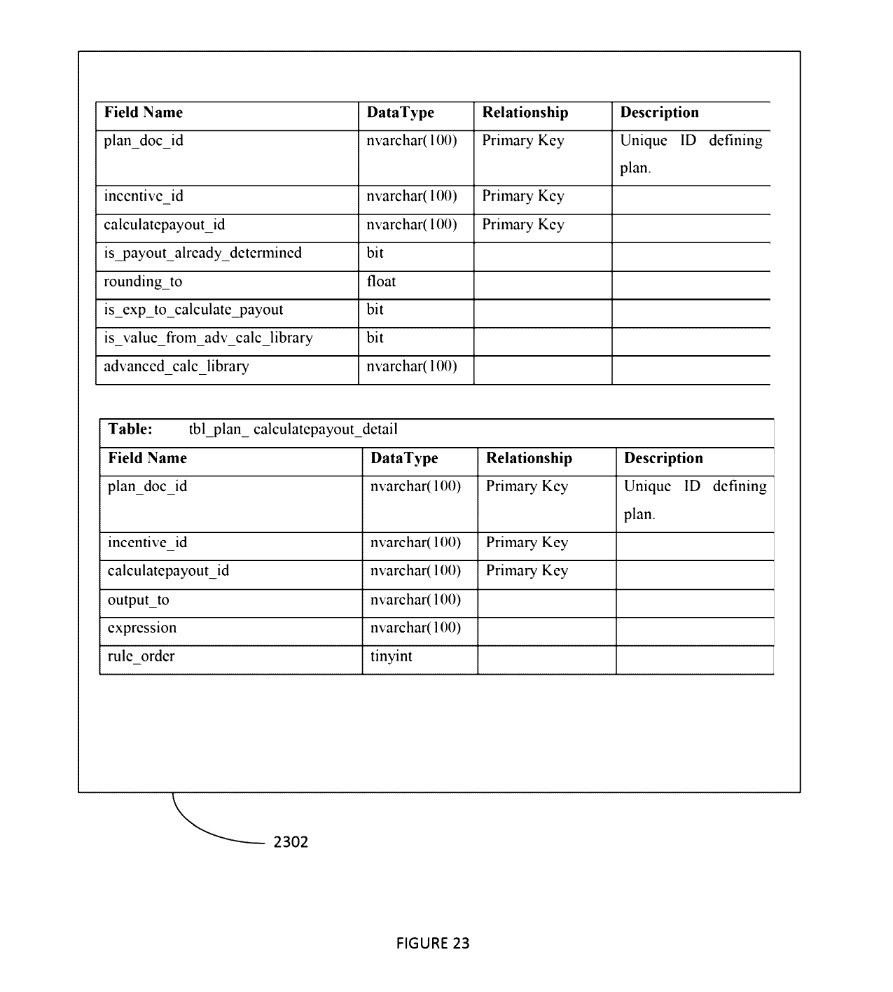

FIG. 22 illustrates an example element of a calculate-payout section 2202 of the plan document, according to some embodiments. FIG. 23 illustrates example tables 2202 that describe data plans for calculating payout rates, according to some embodiments.

A commission-plan designer can implement two options with respect to a plan-designer Library. A first option can include accessing the library values. Upon a mouse hover, the library button will be shown. By clicking the button, corresponding library will be shown in a pop-up browser. Once the user chooses the library value, it will be edited in the required control. The plan components having libraries are incentive, goal, credit and commission rate.

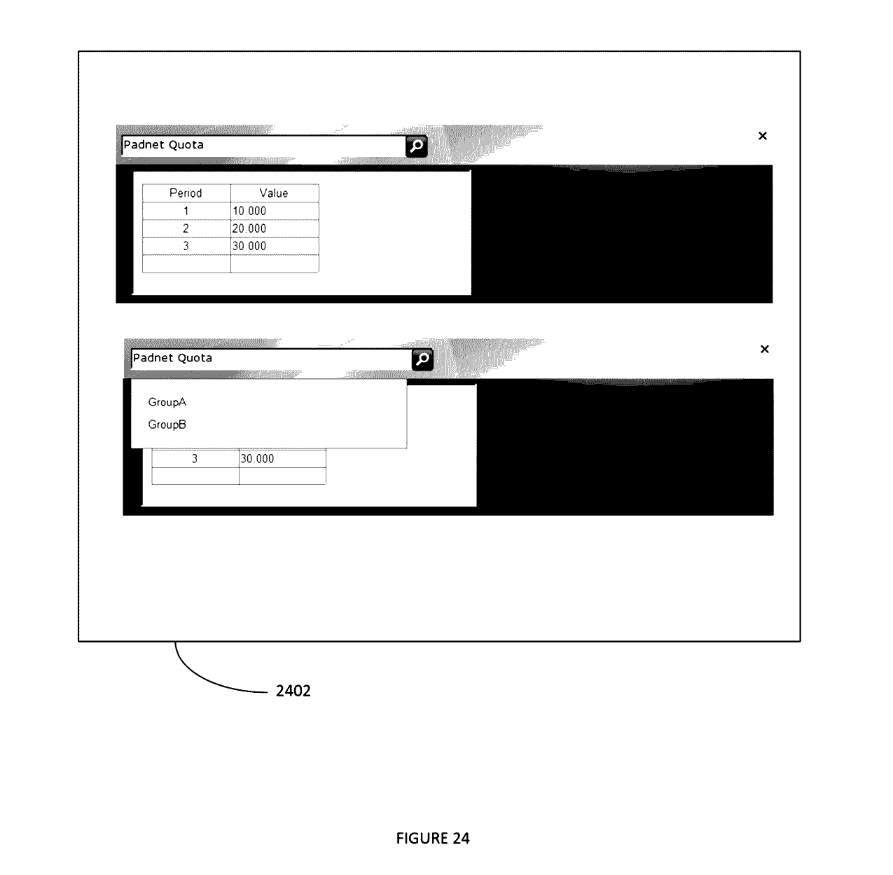

A second option can include adding new values. For example, an ‘Add’ icon can be situated to the right end of the required control's title. Upon clicking the icon, a new value can be added. The incentive and credit have add-on new add-on features. The incentive can also have an ‘Add Incentive’ option at the top end of the commission-plan design document. FIG. 24 illustrates an example of an add-new rules section 2402 of a plan document, according to some embodiments.

### Example Table Types

Various functionalities of a commission-plan design document can be implemented. In some embodiments, two sets of tables (e.g. the tables provided supra) can be used in commission-plan design document. One table type can be a main table where the values are permanently stored. In some examples, these tables can be prefixed with ‘tbl_’. Another table type can utilize temporary tables. Temporary tables can be a replica of a main table. These tables can be prefixed with tmp_and have additional fields such as curr_session and curr_users. Plan-Specific default values can be stored in main thl_tables with following key values as a ‘default’. These values can be loaded when a user creates new plan documents. Some of the default values can include, inter alia agreement tile, agreement description, duration title, duration description etc. Various default plan components can be provided. For example, plan specific default components can be defined in a specified business logic. Some of the default plan components can include, inter alia: duration, one incentive, draw, cap, pan approval etc. The following temporary tables can be implemented: tmp_plan_info, tmp_plan_incentive, tmp_plan_incentive_credit, tmp_plan_incentive_commissionrate, tmp_plan_incentive_commissionrate_detail_diff_rates, tmp_plan_incentive_commissionrate_detail_rate_lookup, tmp_plan_incentive_calculatepayout. Examples of said tables are provided supra in FIGS. 1-3, 12, 16-17, 19-21 and 23.

### Additional Exemplary Computer Architecture and Systems

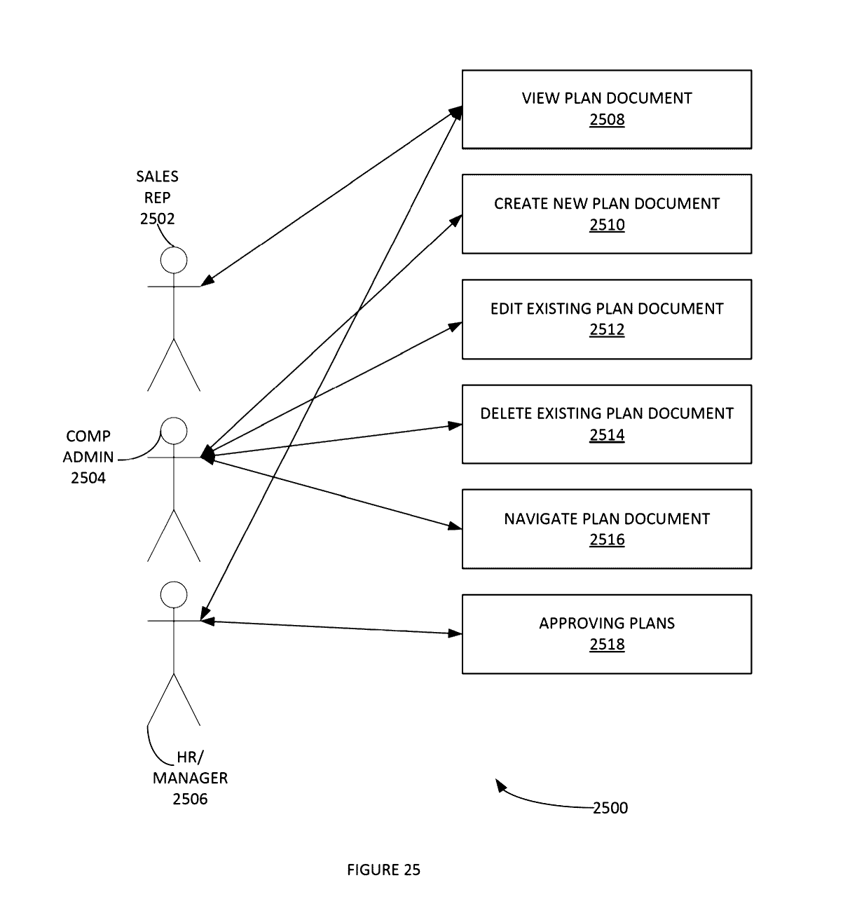

FIG. 25 illustrates a set of entities and each entity's particular permissions with respect to various commission-plan document modes, according to some embodiments. More particularly FIG. 25 provides three entities: sales rep 2502, comp admin 2504 and HR/Manager 2506. Various commission-plan document modes are also provided such as modes 2508-2518. Permission to access a mode is indicated by a connecting arrow.

FIG. 26-27 illustrates example systems used to logically store commission-plan document data in the system. Plan document designer's data are stored and retrieved from Plan Document Design (PDD) database. The plan related library entries/lookup values can be directly accessed from QC objects in the system.

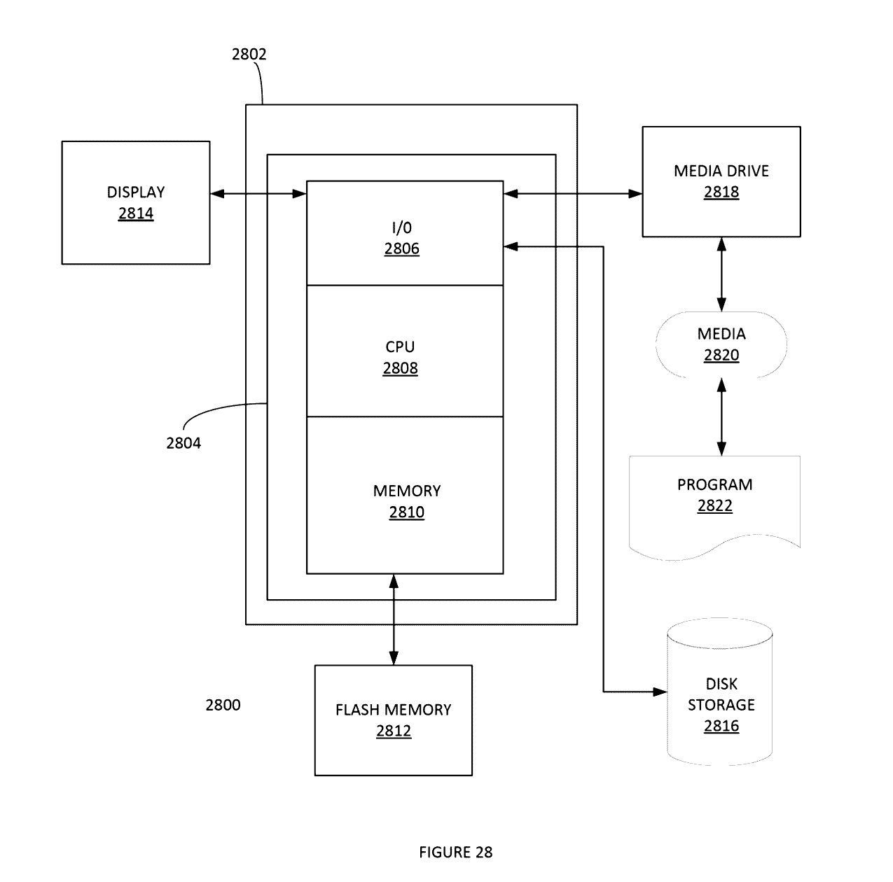

FIG. 28 depicts an exemplary computing system 2800 that can be configured to perform any one of the processes provided herein. In this context, computing, system 2800 may include, for example, a processor, memory, storage, and devices (e.g., monitor, keyboard, disk drive. Internet connection, etc,). However, computing system 2800 may include circuitry or other specialized hardware for carrying out some or all aspects of the processes. In some operational settings, computing system 2800 may be configured as a system that includes one or more units, each of which is configured to carry out some aspects of the processes either in software, hardware, or some combination thereof.

FIG. 28 depicts computing system 2800 with a number of components that may be used to perform any of the processes described herein. The main system 2802 includes a motherboard 2804 having an I/O section 2806, one or more central processing units (CPU) 2808, and a memory section 2810, which may have a flash memory card 2812 related to it. The 110 section 2806 can be connected to a display 2814, a keyboard and/or other user input (not shown), a disk storage unit 2816, and a media drive unit 2818. The media drive unit 2818 can read/write a computer-readable medium 2820, which can contain programs 2822 and/or data. Computing system 2800 can include a web browser. Moreover, it is noted that computing system 2800 can be configured to include additional systems in order to fulfill various functionalities. Computing system 2800 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

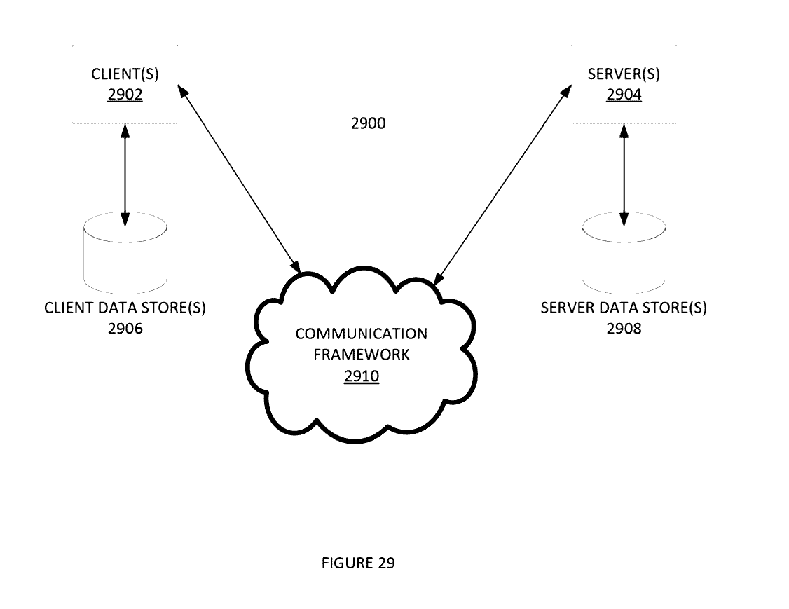

FIG. 29 is a block diagram of a sample-computing environment 2900 that can be utilized to implement various embodiments. The system 2900 further illustrates a system that includes one or more client(s) 2902. The client(s) 2902 can be hardware and/or software (e.g., threads, processes, computing devices). The system 2900 also includes one or more server(s) 2904. The server(s) 2904 can also be hardware and/or software (e.g., threads, processes, computing devices). One possible communication between a client 2902 and a server 2904 may be in the form of a data packet adapted to be transmitted between two or more computer processes. The system 2900 includes a communication framework 2910 that can be employed to facilitate communications between the client(s) 2902 and the server(s) 2904. The client(s) 2902 are connected to one or more client data store(s) 2906 that can be employed to store information local to the client(s) 2902. Similarly, the server(s) 2904 are connected to one or more server data store(s) 2908 that can be employed to store information local to the server(s) 2904. In some embodiments, system 2900 can instead be a collection of remote computing services constituting a cloud-computing platform.

### Additional Material

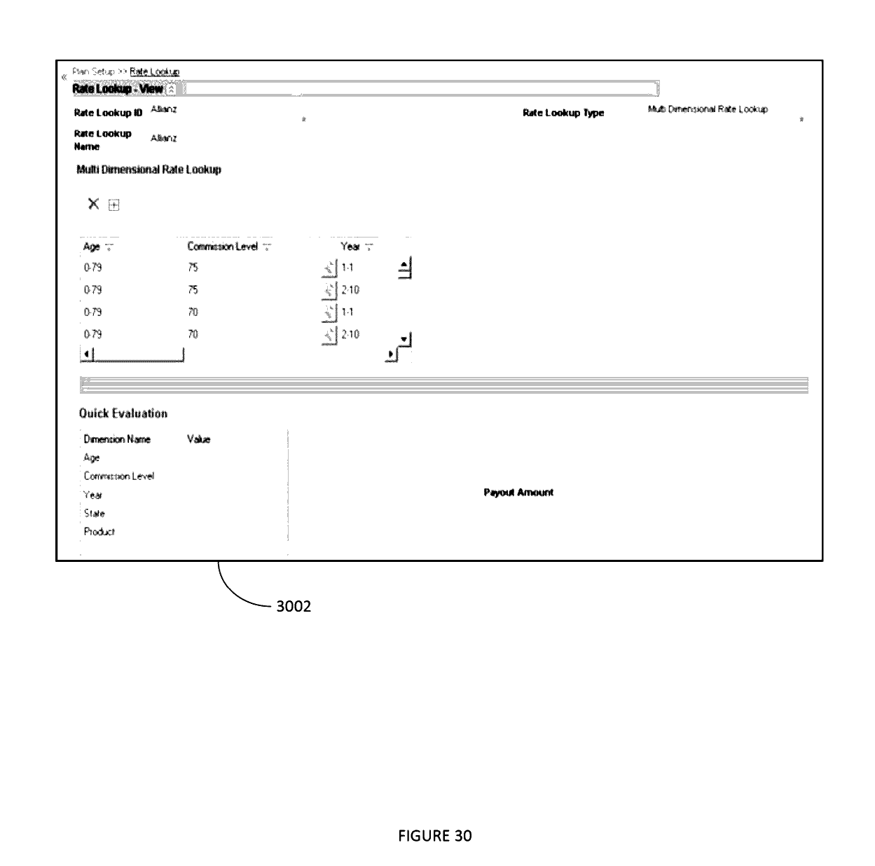

FIG. 30 illustrates an example screenshot implementing a multi-dimensional rate lookup, according to some embodiments. A matrix made up of one (1) to any number of dimensions. Each dimension can have a set of values, each of which can be a number, text, or a range of values. Each intersection of a unique value from all the dimensions can produce a specific result. A multi-dimensional screen can be used to enter the data. Calling programs can provide a specific set of values for all the dimensions and get a result back.

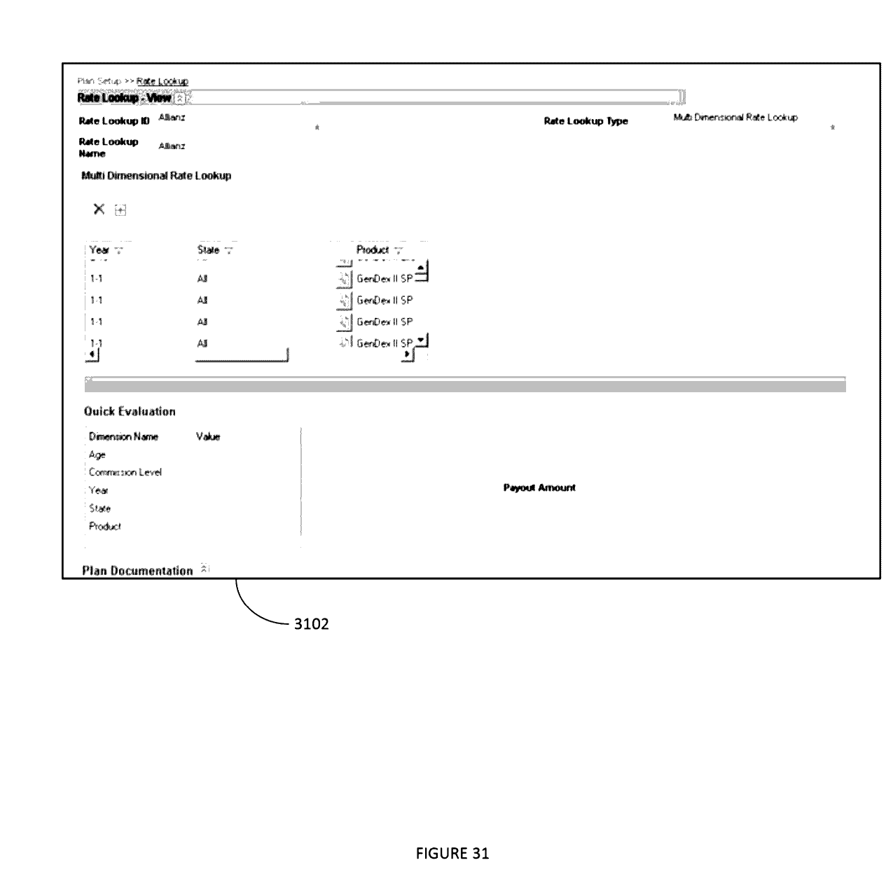

FIG. 31 illustrates an example screenshot implementing sales commission modeling, according to some embodiments. Model sales commission costs can be determined given a number of business conditions. For a given combination of job role, business unit, periods, performance goals, prior performance and projected performance and/or compensation plan rules can be used to calculate comprehensive compensation expectations by individuals.

In one embodiment, multi-point record security can be implemented. For example, records in database tables are protected by multiple layers of security. Role security, user security, data object security, specific data value protection, specific record ownership, position of owner within organizational structure can be combined to secure the access to a specific record and provide the appropriate access to a user.

In one embodiment, a learning application can be implemented. A system user can modify the system and/or creating new configurations. These actions can be journaled. The journaled information can be assessed. Successful patterns of usage and benefit can be derived and reapplied against the core system, automatically with minor review and/or without new development. With more and more users, the system can learn more and become more capable.

In one embodiment, an application scope can be implemented. For example, in platform as a service system., various objects can be specified a scope. The scope can indicate the level at which it is applicable. The scope level can include system, application, industry and/or installation. The lowest level can be unique to each entity in that level.

### Conclusion

Although the present embodiments have been described with reference to specific example embodiments, various modifications and changes can be made to these embodiments without departing from the broader spirit and scope of the various embodiments. For example, the various devices, modules, etc. described, herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing, system (e.g., a computer system), and can be performed in any order (e.g., including using means for achieving, the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A method implementing a commission-plan document designer application comprising:
providing a sales-commission plan document, wherein the sales-commission plan document comprises a digital document;
providing a set of rules that governs a sales-commission calculation for when a sales representative receives credit for a sale;
generating a set of sales-commission computer-executable algorithms for calculating the sales commission based on the set of rules;
embedding the set of rules that govern a sales-commission calculation and the set of sales-commission computer-executable algorithms into the sales-commission plan document to generate an executable sales-commission plan document; and
storing the executable sales-commission plan document in the computer memory.

2. The method of claim 1, wherein the sales-commission plan document comprises a set of graphical-control elements that enable an administrator to input the set of rules into the sales-commission plan document.

3. The method of claim 2, wherein the set of graphical-control elements comprises a text-input box element, a check box element and a radio button element.

4. The method of claim 3, wherein the commission-plan document comprises a rich-text file format.

5. The method of claim 4, wherein the set of rules are embedded in an Extensible Markup Language (XML) format.

6. The method of claim 5, wherein the set of rules comprises at least one rule that defines an eligible geographic region for a sale, at least one eligible customer identifier and at least one eligible product line identifier.

7. The method of claim 6, wherein the set of rules comprises attributes of a sales-commission calculation process.

8. The method of claim 7, wherein the attributes of the sales-commission calculation process comprises a specified percentage of sales profits used for commission, a specified sales quota, and a duration of the sales-commission plan.

9. The method of claim 8, wherein upon completion of a sale, providing a sale data to a calculation engine of the commission-plan document designer application.

10. The method of claim 9, wherein the calculation engine obtains the set of sales-commission computer-executable algorithms from the executable sales-commission plan document and automatically calculates a payout amount to the sales representative.

11. A computerized system comprising:
a processor configured to execute instructions;
a memory containing instructions when executed on the processor, causes the processor to perform operations that:
provide a sales-commission plan document, wherein the sales-commission plan document comprises a digital document;
provide a set of rules that govern a sales-commission calculation for when a sales representative receives credit for a sale;
generate a set of sales-commission computer-executable algorithms for calculating the sales commission based on the set of rules;
embed the set of rules that govern a sales-commission calculation and the set of sales-commission computer-executable algorithms into the sales-commission plan document to generate an executable sales-commission plan document; and
store the executable sales-commission plan document in the computer memory.

12. The computerized system of claim 11, wherein the sales-commission plan document comprises a set of graphical-control elements that enable an administrator to input the set of rules into the sales-commission plan document.

13. The computerized system of claim 12, wherein the set of graphical-control elements comprises a text-input box element, a check box element and a radio button element.

14. The computerized system of claim 13, wherein the commission-plan document comprises a rich-text file format.

15. The computerized system of claim 14, wherein the set of rules is embedded in an Extensible Markup Language (XML) format.

16. The computerized system of claim 15, wherein the set of rules comprises at least one rule that defines an eligible geographic region for a sale, at least one eligible customer identifier and at least one eligible product line identifier.

17. The computerized system of claim 16, wherein the set of rules comprises attributes of a sales-commission calculation process.

18. The computerized system of claim 17, wherein the attributes of the sales-commission calculation process comprises a specified percentage of sales profits used for commission, a specified sales quota, and a duration of the sales-commission plan.

19. The computerized system of claim 18, wherein upon completion of a sale, providing a sale data to a calculation engine of the commission-plan document designer application.

20. The computerized system of claim 19, wherein the calculation engine obtains the set of sales-commission computer-executable algorithms from the executable sales-commission plan document and automatically calculates a payout amount to the sales representative.
